(19) United States
(12) Patent Application Publication
(10) Pub. No.: US 2015/0224816 A1
(43) Pub. Date: Aug. 13, 2015

(54) SHARPENER FOR MARKING INSTRUMENTS

(71) Applicant: MELISSA & DOUG, LLC, Wilton, CT (US)

(72) Inventor: Ken Weiland, Brookfield, CT (US)

(21) Appl. No.: 14/620,394

(22) Filed: Feb. 12, 2015

Related U.S. Application Data
(60) Provisional application No. 62/040,128, filed on Aug. 21, 2014.
(60) Provisional application No. 61/938,970, filed on Feb. 12, 2014.

(51) Int. Cl. B43L 23/08; B43L 23/00

(52) U.S. Cl. CPC B43L 23/08; B43L 23/004

(57) ABSTRACT

A sharpener for marking instruments such as pencils and crayons, including a blade holder with a throat having a blade mounted to engage and sharpen an inserted end of a pencil, and a squeezer having plural members extending toward the throat and resiliently biased for gripping a pencil inserted into the throat, to enable sharpening of pencils of differing cross-sectional dimensions, while inhibiting insertion of a child's finger into the throat. An external housing enclosing the holder and squeezer provides a trap to collect shavings cut by the blade and further protects fingers from the blade. A separate plastic-bladed sharpening element can be mounted on the trap opposite the blade holder to accommodate crayons.

### CROSS REFERENCE TO RELATED APPLICATIONS

This application claims the benefit, under 35 U.S.C. §119(e), of U.S. provisional patent applications No. 61/938,970, filed Feb. 12, 2014, and No. 62/040,128, filed Aug. 21, 2014, the entire disclosures of both of which are incorporated herein by this reference.

### BACKGROUND OF THE INVENTION

This invention relates to sharpeners for marking instruments such as pencils and crayons. In a particular sense, the invention is directed to small, manually operable hand-held sharpeners.

A marking instrument as herein contemplated usually has an elongated rod or column of marking material (e.g., graphite, crayon wax, and various cosmetic products) that is applied endwise on a paper or other receiving surface to make marks and becomes progressively consumed in use. In pencils, for instance, the column of marking material is laterally enclosed in a supporting and protecting sheath of wood or the like; crayons have a column of marking material that is sufficiently rigid and self-sustaining so that no sheath is necessary. As the applied end of the column of marking material is worn, the instrument must be sharpened by the removal of marking (and, if present, sheath) material at an end thereof, to provide a generally conical tip that exposes additional marking material and/or restores a desired fine marking point. As herein used, the term “marking instruments” refers generically to marking, writing, drawing and cosmetic instruments of the types thus described that require periodic endwise sharpening to provide or refine a conical tip.

Diverse techniques and devices are known for sharpening pencils and crayons. These range from simple paring of a pencil or crayon end with a knife to the provision of stationary, relatively large and costly mechanical apparatus in which a pencil is manually fed lengthwise through an aperture into sharpening contact with contained rotary blades that are turned by a hand crank or an electric motor. The housing includes a trap to collect material shaved from the pencil and is periodically removed for cleaning.

It is often convenient to use a simple inexpensive hand-held pencil sharpener such as a so-called prism sharpener, which has a small rectangular molded plastic body with a pencil-receiving opening in one end, from which a tapering throat extends through the body. The throat also opens to the exterior through a slot along one side; a cutting blade mounted in this slot engages the end portion of the inserted pencil to shave wood and graphite therefrom, when the pencil is rotated manually relative to the blade. Material removed by the blade escapes from the throat through the slot. The sharpening operation may be performed over a wastebasket, which receives the shaved material.

A disadvantage of many present-day manual, mechanical and electric pencil sharpeners is that they are limited to sharpening pencils or crayons having only one particular cross-sectional diameter or dimension. Satisfactory sharpening of a pencil or crayon depends on stable maintenance of a fairly critical angular orientation of the sharpening blade relative to the long axis of the pencil or crayon being sharpened (“long axis” in this context refers to the longitudinal axis of the rod or column of graphite, crayon wax or other marking material); if the orientation is incorrect or inconstant, the desired symmetrically conical sharpened end of the pencil or crayon will not be achieved, and the resultant pencil or crayon tip may be difficult to use or indeed useless. In a prism sharpener, the relative orientation of pencil and blade is primarily determined only by the shape and dimensions of the throat, which serves as a guide. A throat large enough to serve as a guide for one diameter (cross-sectional dimension) of pencil or crayon may be too large for a smaller diameter and too small to accommodate a larger diameter. Yet, it would frequently be desirable to sharpen pencils and crayons of different diameters with the same device, for example in schools or households with young children, who use marking instruments ranging from thin pencils to large crayons.

Another problem is the potential for injury to children from sharpener blades. Insertion of a child's finger into a blade-bearing pencil or crayon sharpener throat can result in cuts, particularly in the case of sharpeners large enough to accommodate crayons. Extensive efforts have been made to “child-proof” various kinds of potentially injurious or hazardous devices, but known types of pencil sharpeners—and, especially, simple hand-held sharpeners—typically lack such protection.

### SUMMARY OF THE INVENTION

The present invention broadly contemplates the provision of a sharpener for marking instruments, comprising a blade holder with a throat having a blade mounted therein to engage and sharpen an end portion of a pencil inserted in the throat, and a squeezer disposed forwardly of the throat for resiliently gripping or squeezing the shaft of a pencil inserted in the sharpener while inhibiting insertion of a child's finger into the throat, wherein the resilient squeezer is capable of gripping or squeezing pencil shafts of any of a range of differing cross-sectional dimensions.

In particular embodiments, the sharpener of the invention comprises, in combination, a sharpening blade for removing material from an end portion of a pencil; a blade holder having a throat with an open forward end for receiving an end portion of a pencil inserted longitudinally into the open end, the holder securing the blade in a position for engaging and removing material from an inserted end portion of a pencil within the throat to sharpen the pencil when the holder and the pencil are rotated, relative to each other, about a long axis of the pencil; and a squeezer, disposed forwardly of the throat in a path of longitudinal insertion of a pencil into the throat, including plural members extending toward the throat along the path and resiliently biased toward each other for permitting pencils over a range of different cross-sectional dimensions to be longitudinally inserted into the throat while laterally pressing the inserted pencil between them, and for inhibiting insertion of a human finger into the throat.

The plural members can be two convergent members respectively having free end portions extending toward the throat on opposite sides of the path. The squeezer may be an integral molded plastic element, and the two members may respectively have converging forward shoulder portions and facing rearward free end portions. Advantageously or preferably, these free end portions respectively have facing longitudinal grooves for receiving and pressing against opposed side portions of a pencil inserted between them.

The sharpener in accordance with the invention can also include housing structure laterally surrounding and mounting the holder and squeezer. The housing structure may comprise a trap for receiving and containing material removed from an end portion of a pencil by the blade within the throat, the holder defining an aperture for discharge of the removed material from the throat into the trap. The trap can include two semicylindrical portions interfitting with each other and with the holder to secure the holder and trap portions together in fixed relation to each other, the trap having open front and rear ends.

As additional features, the sharpener may also include an open-ended cylindrical outer trap element surrounding the interfitting semicylindrical portions, a cap removably closing the open rear end of the trap, and a forward cover fitting over and enclosing the squeezer, the forward cover and the squeezer being secured to the forward open end of the trap by interfitting engagement therewith, and the forward cover having a forward opening for longitudinal insertion of a pencil therethrough between the two members of the squeezer and into the throat.

In another aspect, the invention contemplates the provision of a sharpener that includes, in combination with the elements as described above, a crayon sharpener element removably mountable on the open rear end of the trap with a throat for receiving and sharpening a crayon inserted endwise therein in a direction opposite to that in which a pencil is inserted into the throat of the blade holder. The crayon sharpener element may be dedicated to sharpening crayons, and may therefore have a molded plastic blade, which does not require a squeezer for prevention of injury to children's fingers. Advantageously, the entire crayon sharpener element including its throat and plastic blade may be a unitary, integral molded plastic element formed with an outer chamber surrounding its throat and communicating with the trap through the open rear end thereof so that crayon scrapings, discharged through an aperture in the crayon sharpener element throat, can be collected in the trap. The crayon sharpener element in this embodiment serves as a removable cap for the trap, to enable the trap to be emptied as needed. Provision of the squeezer and blade holder with, typically, a metal blade, and a dedicated crayon sharpener element, at opposite ends of the sharpener device facilitates accommodation of a larger range of pencil and crayon diameters than may otherwise be conveniently possible, without derogating from the protective function of the squeezer associated with the sharp blade employed for sharpening pencils.

Further features and advantages of the invention will be apparent from the detailed description hereinbelow set forth, together with the accompanying drawings.

### BRIEF DESCRIPTION OF THE DRAWINGS

FIG. 1 is a perspective view of an assembled pencil sharpener embodying the present invention as a particular form;

FIG. 2 is an exploded perspective view of the sharpener of FIG. 1;

FIG. 3 is an exploded elevational view of the same sharpener;

FIG. 4 is an exploded sectional view of the same sharpener, taken along the plane 4-4 of FIG. 3;

FIGS. 5A, 5B, 5C and 5D are, respectively, a front end view, a top view, an elevational view and a rear end view of the sharpener of FIG. 1 in assembled condition;

FIG. 6 is a sectional view of the same sharpener taken along the plane 6-6 of FIG. 5C;

FIG. 7 is another sectional view of the same sharpener, taken along the plane 7-7 of FIG. 5D;

FIGS. 8A, 8B, 8C and 8D are, respectively, a perspective view, a rear end view, a front view and a top view of the squeezer of the sharpener of FIG. 1;

FIG. 9 is a perspective view, similar to FIG. 1, of another embodiment of the invention. for sharpening crayons as well as pencils;

FIG. 10 is an exploded perspective view, from the same direction as FIG. 9, of the sharpener of FIG. 9;

FIG. 11 is a perspective view, from another direction, of the sharpener of FIG. 9;

FIG. 12 is an exploded perspective view, from the same direction as FIG. 11, of the sharpener of FIG. 9;

FIG. 13 is an exploded perspective view, similar to FIG. 12 but at a smaller scale, illustrating features of operation of the sharpener of FIG. 9;

FIGS. 14A, 14B and 14C are, respectively, a front end view, an elevational view, and a rear end view of the sharpener of FIG. 9 in assembled condition;

FIG. 15 is a sectional view of the sharpener of FIG. 9 taken along the plane 15-15 of FIG. 14B; and

FIG. 16 is an enlarged end view of a modified crayon sharpener element for use in a sharpener of the type of FIG. 11, illustrating an alternative arrangement of blades and slots therein.

### DETAILED DESCRIPTION

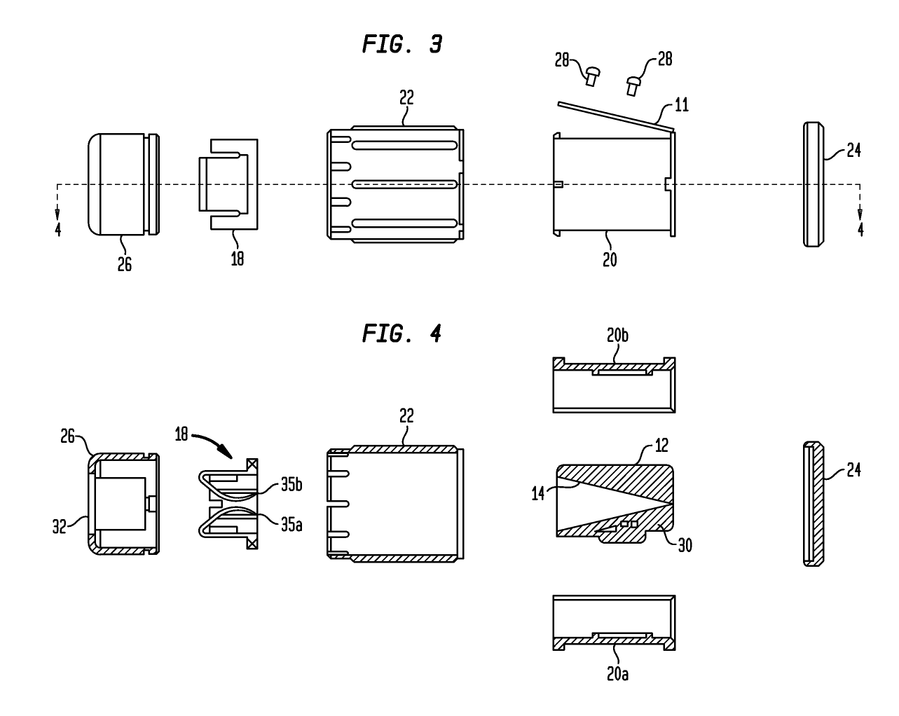

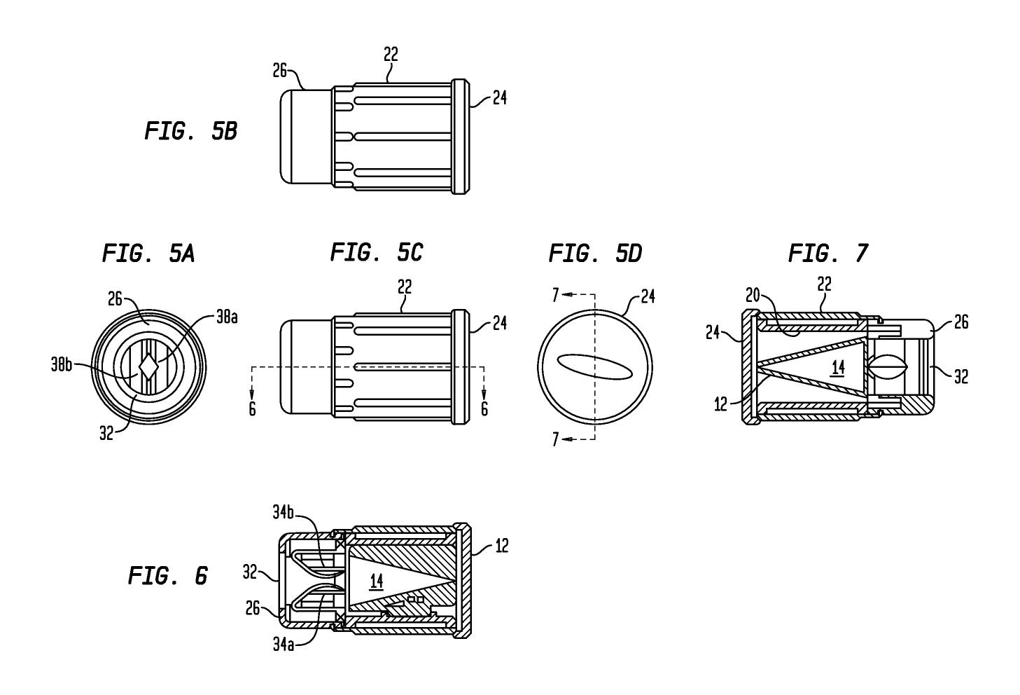

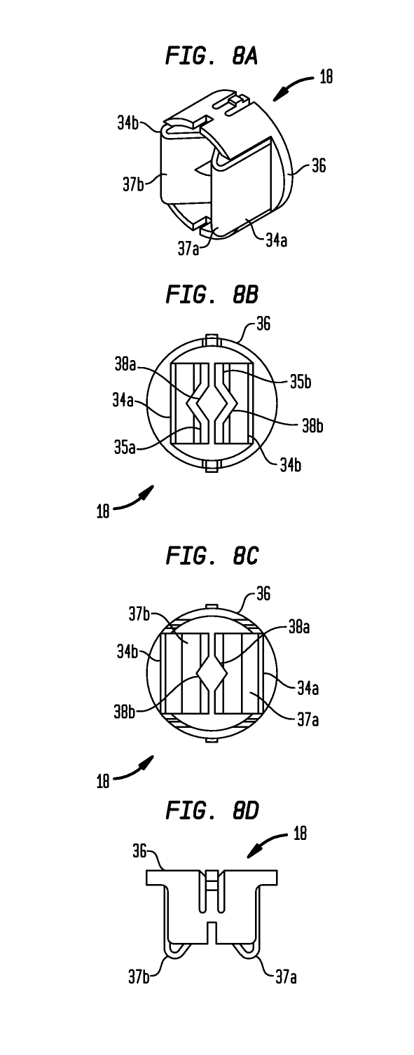

In FIGS. 1-8D, the invention is illustrated as embodied in a hand-held marking instrument sharpener 10 including a sharpening blade 11, a blade holder 12 defining a forwardly opening aperture or throat 14 for receiving an end of a pencil to be sharpened and a slot 16 in which the blade is mounted, a squeezer 18 disposed forwardly of the throat 14 for resiliently gripping or squeezing the shaft of a pencil inserted in the sharpener, inner and outer open-ended cylindrical traps 20 and 22 concentrically surrounding the blade holder, a cap 24 closing the open rearward end of the outer trap 22, and a forward cover 26 surrounding and enclosing the squeezer. Each of these components (except for the blade, which is typically made of plated steel, and the inner trap, described below) can be a unitary, integral injection molded plastic piece, dimensioned and formed with flanges, ribs, lips, grooves and the like to enable them to be securely assembled together as a unit in interfitted and/or snap-fitted relation to each other. The inner trap 20, in the embodiment shown, is constituted of two injection-molded plastic half-cylinders 20a and 20b that interfit with each other and with the blade holder 12 to provide a stable subassembly; further, parts 20a and 20b are sealed within outer trap 22 to provide a double-entrapped assembly that protects against the sharpener being broken apart and creating a hazard for a young user. The design and arrangement of suitable flanges, lips and other interfitting features for the components of the assembled sharpener unit and the subassembly will be readily apparent to persons skilled in the art.

Screws 28 secure the blade 11 to a flange 30 of the blade holder 12, adjacent the slot 16, such that the sharp edge of the blade projects through the slot into the throat 14 for engaging and shaving an end portion of a pencil (not shown) inserted in the throat, to shape the pencil end portion into a more or less sharply pointed conical end during relative rotation of the blade holder and the pencil about the long axis of the latter. Typically the blade is a sharp metal blade suitable for shaving a wooden sheath of a pencil.

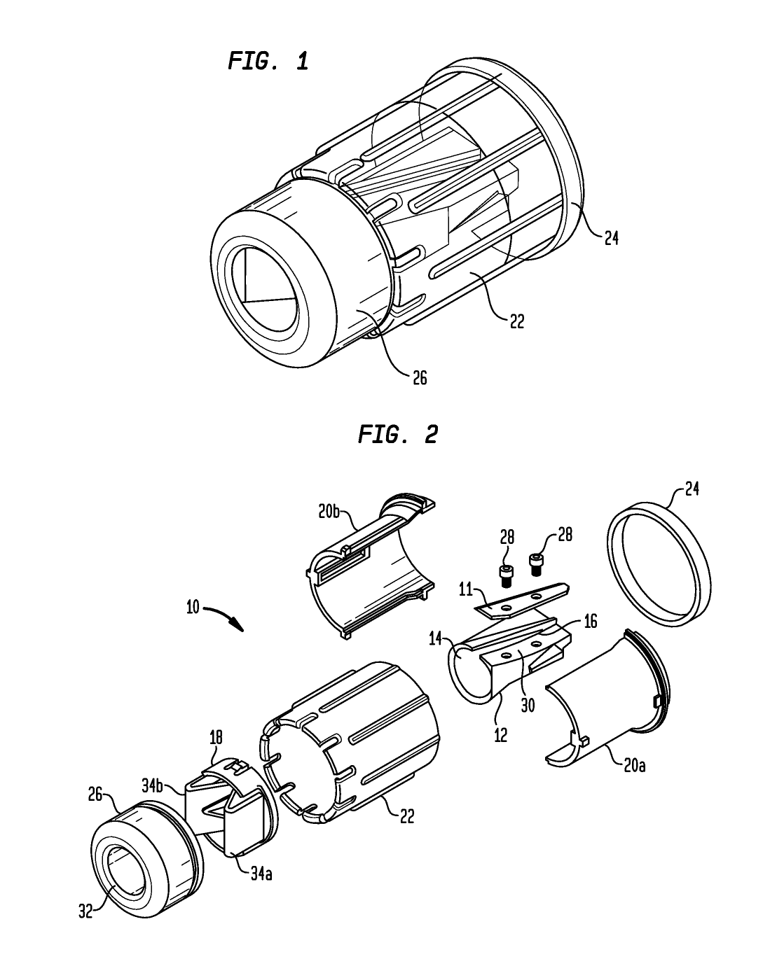

The forward cover 26 has a central hole 32 in its front end to enable a pencil to be inserted endwise into the sharpener with its leading end passing through the squeezer and into the throat for sharpening. Terms such as “front,” “forward,” and “forwardly” herein refer to the end of the sharpener through which an inserted pencil enters this hole (the left-hand end in FIGS. 1 and 2) and to orientations toward that end, while terms such as “back,” “rear,” “rearward” and “rearwardly” refer to the opposite end (the right-hand end in FIGS. 1 and 2) of the sharpener and to the direction in which an inserted pencil is advanced through the sharpener toward the blade holder.

Suitable materials for the injection molded components of the sharpener include acrylonitrile butadiene styrene (ABS) plastic for the blade holder, inner and outer traps and forward cover 26, a TPE plastic for the cap 24, and polyoxymethylene plastic (commercially available under the trade name “DELRIN,” for example) for the squeezer 18.

As a particular feature of the invention, the resilient squeezing or gripping of a pencil shaft by the squeezer 18 cooperates with the blade holder throat 14 to maintain the long axis of an inserted pencil stably and properly angularly positioned in relation to the blade, as the pencil and the blade undergo relative rotation about that axis, so that satisfactory sharpening action is achieved, for pencils throughout a substantial range of different shaft cross-sectional dimensions. That is to say, the resilience of the squeezer accommodates different shaft cross-sectional sizes. The squeezer resilience is such that a rigid pencil can readily be pushed through the squeezer, but if a child inserts a finger into the front cover hole 32, the squeezer will pinch the finger and (though not harming the finger) will thereby produce sufficient discomfort to deter the child from attempting to thrust the finger further into the sharpener, where contact with the blade could cause real injury.

In exemplary and currently preferred embodiments of the invention, the squeezer 18 includes plural arms or members (two such members, 34a and 34b, in opposed relation to each other, being shown in the drawings) that extend toward the throat 14 along the path of longitudinal advance of a pencil inserted into the sharpener through the hole 32, and are resiliently biased toward each other for enabling pencils of a range of cross-sectional dimensions to be thus inserted into the throat 14 while laterally pressing or squeezing the shaft of the inserted pencil between them, and also for inhibiting insertion of a child's finger into the throat.

As illustrated, the two opposed members 34a and 34b are convergent, respectively having free end portions 35a and 35b extending toward the throat 14 on opposite sides of the aforesaid path. The squeezer 18 has a cylindrical rear end 36, from which the members 34a and 34b (formed integrally therewith) extend initially forwardly, then bend inwardly (toward each other) and rearwardly at shoulders 37a and 37b, such that the shoulders converge toward each other and the free end portions 35a and 35b face each other. Advantageously, these free end portions respectively have facing longitudinal grooves 38a and 38b for receiving and pressing against opposed side portions of the shaft of an inserted pencil.

The front cover hole 32 and the throat 14 are both large enough to receive a pencil of the maximum cross-sectional size for which the sharpener can be used, while the minimum spacing (unstressed spacing) between the inwardly biased free end portions of squeezer members 34a and 34b (as measured, in the illustrated embodiment, between the walls of the facing grooves 38a and 38b) is at least slightly less than the minimum cross-sectional size of pencil for which the sharpener can be used.

To sharpen a pencil, the sharpener 10 is held by the outer trap 22 in one hand, and the pencil is inserted endwise through the cover hole 32 by the other hand, with sufficient force so that the advancing end of the pencil pushes the resiliently biased squeezer members 34a and 34b apart. As the pencil continues to advance into the sharpener, its end to be sharpened enters the throat 14 and comes into contact with the blade 11, while its axial orientation is stabilized by the gripping or squeezing of its shaft by the squeezer members. When fully inserted, it is manually rotated about its long axis relative to the blade holder 12 and blade 11 until the desired sharpened conical pencil tip is formed, and is then manually pulled back out of the sharpener.

If, as shown, the grooves 38a and 38b of the free end portions of the squeezer members are shaped to conform to longitudinal ridges or like surface features on the pencil shaft, the elements of the assembled sharpener are so arranged that the squeezer (and, in the illustrated device, the cover 26) rotate with the pencil being sharpened relative to the outer and inner traps 22 and 20, which have the blade holder 12 fixedly disposed within them. This is easily accomplished by suitable design of the interfitting features (lips, grooves, etc.) of the sharpener components.

The traps may be made of transparent plastic to enable the sharpening action to be viewed. As the sharpener is used, shavings from pencils accumulate in the traps; this accumulation is also visible through the trap walls. From time to time, the rear cap 24 is removed to discharge the accumulated shavings; conveniently, the cap is made of a flexible plastic to facilitate such removal. When the cap is removed, plastic ribs in the rearward end of the sharpener prevent children's fingers from reaching and being cut by the blade.

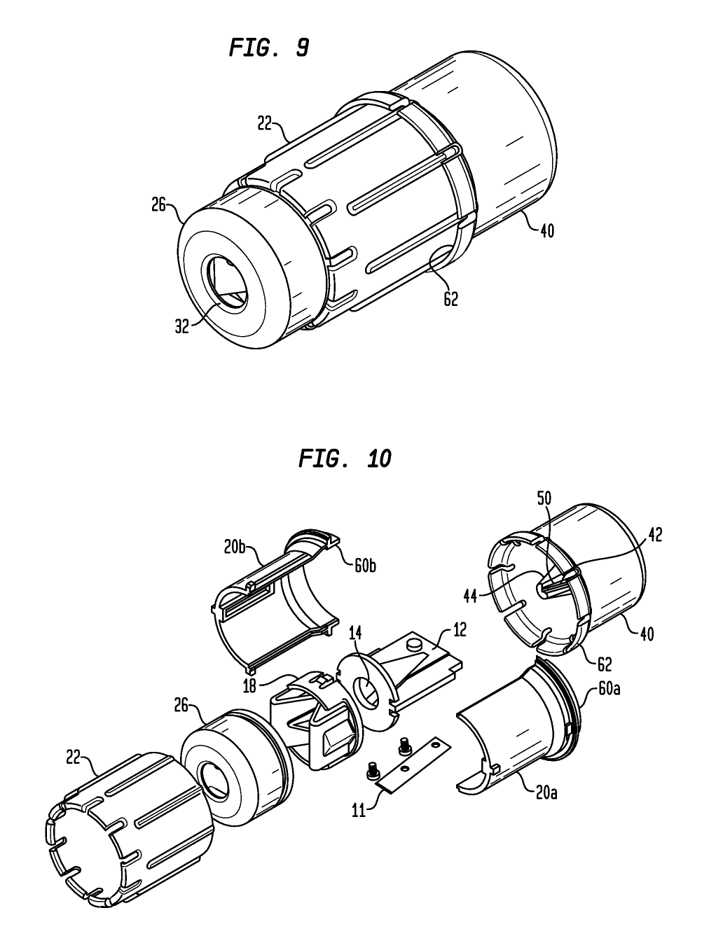

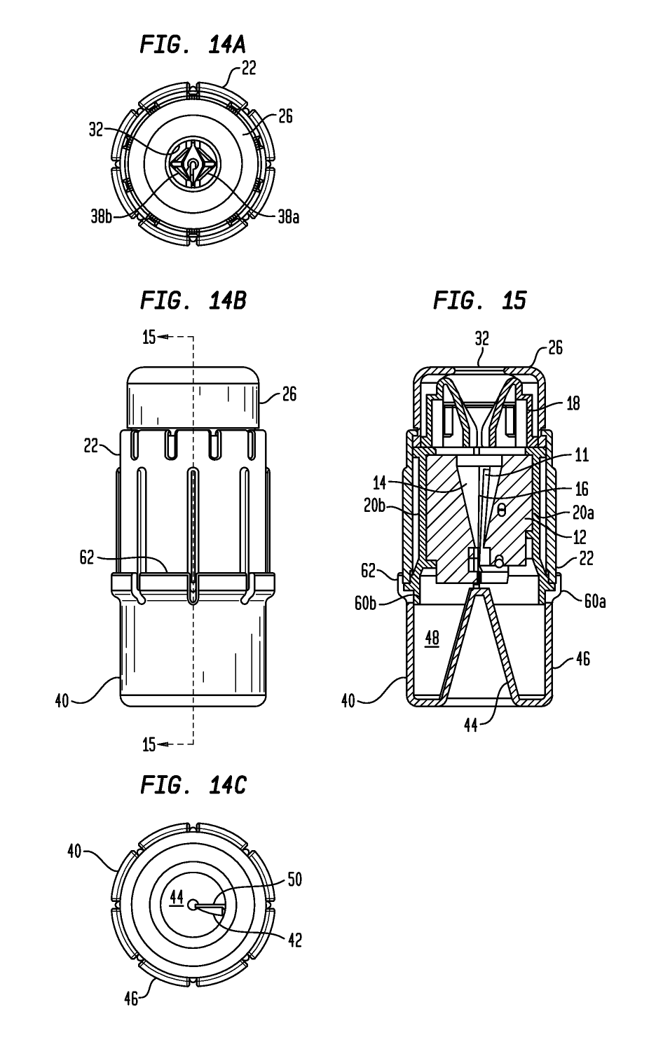

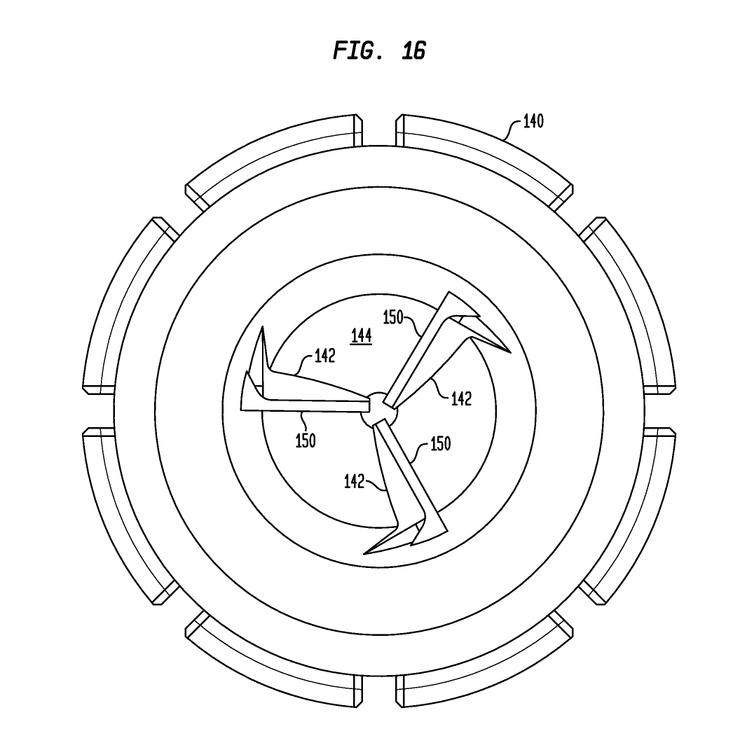

A further embodiment of the invention is illustrated in FIGS. 9-15, wherein elements and features corresponding to those of the embodiment described above (with reference to FIGS. 1-8) are identified by like reference numerals. Like the device of FIGS. 1-8, that of FIGS. 9-15 in fully assembled state is a generally cylindrical article dimensioned to be held in a human hand, preferably dimensioned to be held in the hand of a child.

In the embodiment of FIGS. 9-15, in addition to the blade 11 and blade holder 12 with throat 14 for sharpening a pencil inserted through the front end of the device, there is a second sharpener element 40 including a blade 42 and throat 44 disposed at the opposite (rear) extremity of the device for sharpening a crayon inserted through the rear end of the device. This crayon sharpener element 40 replaces the cap 24 removably closing the open rearward end of the outer trap 22 in the embodiment of FIGS. 1-8. The throat 44 tapers forwardly such that its largest diameter is at its rearward end, which is open for insertion of a crayon to be sharpened.

The illustrated crayon sharpener element 40 also includes a housing portion 46 defining a chamber 48 surrounding the throat 44 and communicating with the trap interior through the aforesaid open rearward end of outer trap 22. A slot 50, similar to the slot 16 of the blade holder 12, is formed in the throat 44, extending along the blade 42 so that the material removed from an end portion of a crayon by blade 42 is discharged from the throat 44 through the slot 50 into the chamber 48 and thence into the trap.

The sharpener element 40 in this embodiment may be dedicated to sharpening crayons. which are larger in diameter or made of softer material than the typically wooden sheath of a pencil and which may be crushed or broken if inserted through sharpening blade 11 or squeezer 18. Accordingly, the blade 42 can be made of molded plastic rather than metal; a plastic blade is sufficiently non-hazardous to obviate provision of a squeezer or like arrangement for protecting children's fingers from injury at the crayon sharpener end of the device.

Illustratively and preferably, the entire crayon sharpener element 40 including the blade 42, the throat 44 and the housing portion 46 is formed as a unitary, integral molded plastic element. It is press-fitted or snap-fitted into the open rearward end of the outer trap element 22, and itself serves as a removable cap for the trap, such that the trap (containing shavings from both the forward blade 11 and the rearward blade 12) can be emptied when desired or necessary. As shown in FIGS. 10, 12 and 15, in this embodiment the inner trap parts 20a and 20b are formed with rearwardly projecting flanges 60a and 60b at their rearward ends for interfitting with the open forward end 62 of the housing portion 46.

An advantage of the embodiment of FIGS. 9-15 is that it facilitates accommodation of marking instruments such as crayons of larger diameters or softer materials than the front-end sharpener assembly of blade holder 12 and squeezer 18, can conveniently be designed to receive.

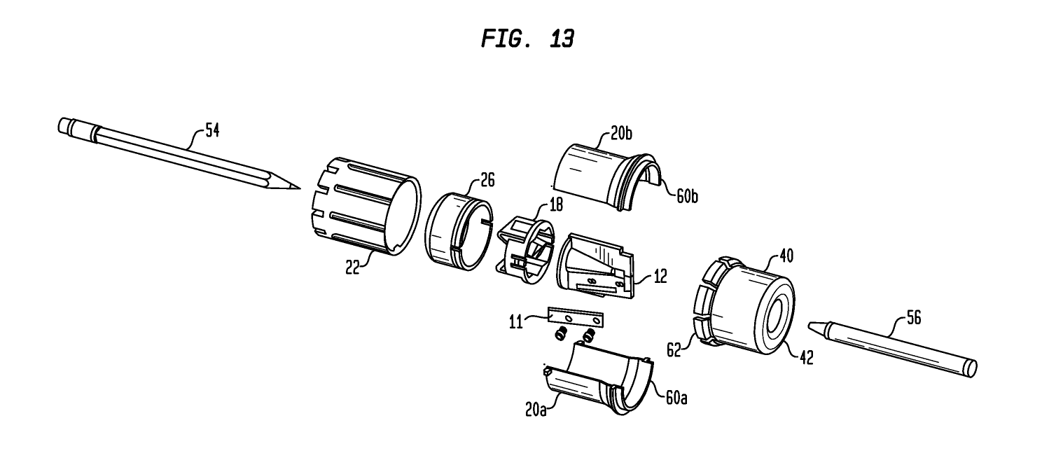

In use of the device of FIGS. 9-15 as shown in FIG. 13, a pencil 54 (e.g. having a shaft anywhere within a range of diameters) is inserted into the front end of the device for sharpening, gripped by the squeezer and rotated about its axis with its tip in contact with the blade 11 until a point of desired sharpness is achieved. Material scraped from the pencil passes into the trap and collects there. Crayons of a wide range of diameters and materials, as represented by crayon 56 in FIG. 13, can be sharpened by insertion lengthwise (in a direction opposite to the direction of insertion of pencil 54) into the crayon sharpener element 40 and rotated to cause the blade 42 to shave material from the crayon tip. The shaved material passes through the aperture 50 into the chamber 52. Shavings from both blades may move between the trap and the chamber 52, but this is of no consequence because the throat 44, even with the aperture 50, effectively prevents leakage of shavings out of the rear end of the device.

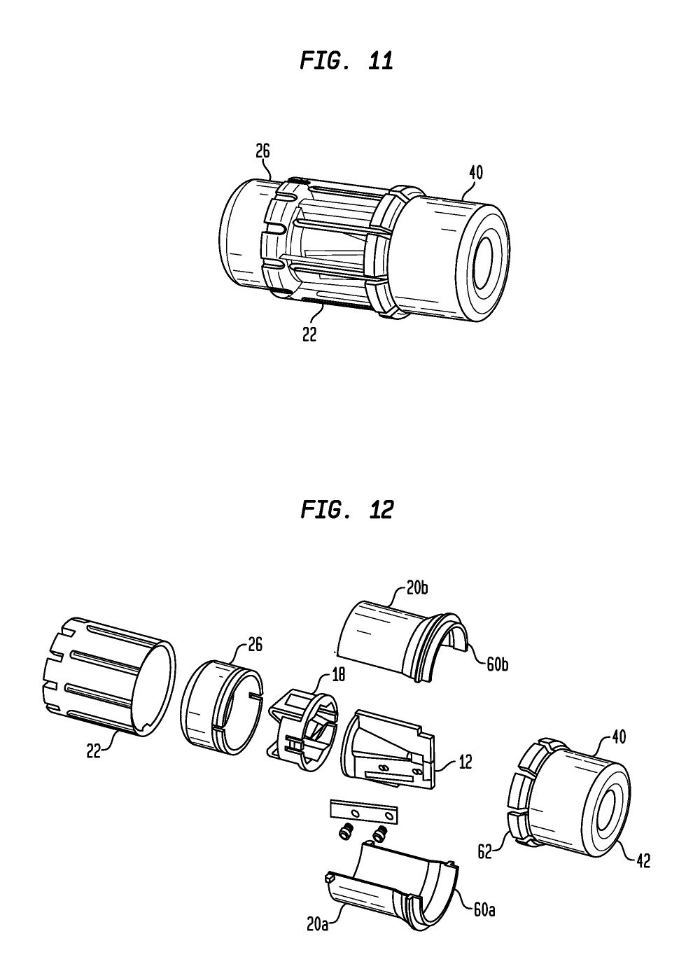

The modified embodiment of the sharpener of the invention shown in FIG. 16 is generally similar to that of FIG. 11, except that its crayon sharpener element 140 (which may otherwise be the same in structure and disposition as the element 40 described above) is formed with plural molded plastic blades and associated slots (e.g., as shown, three such blades 142, spaced 120° apart around the throat 144, each having a slot 150 extending along the blade) rather than a single blade-and-slot combination, to facilitate even and effective shaving of a crayon tip.

It is to be understood that the invention is not limited to the features and embodiments hereinabove specifically set forth, but may be carried out in other ways without departure from its spirit.

What is claimed is:

1. A sharpener for marking instruments, comprising a blade holder with a throat having a blade mounted therein to engage and sharpen an end portion of a pencil inserted in the throat, and a squeezer disposed forwardly of the throat for resiliently gripping or squeezing a shaft of a pencil inserted in the sharpener while inhibiting insertion of a child's finger into the throat, wherein the resilient squeezer is capable of gripping or squeezing pencil shafts having any of a range of differing cross-sectional dimensions.

2. A sharpener for marking instruments, comprising, in combination,
(a) a sharpening blade for removing material from an end portion of a pencil;
(b) a blade holder having a throat with an open forward end for receiving an end portion of a pencil inserted longitudinally into the open end, the holder securing the blade in a position for engaging and removing material from an inserted end portion of a pencil within the throat to sharpen the pencil when the holder and the pencil are rotated, relative to each other, about a long axis of the pencil; and
(c) a squeezer, disposed forwardly of the throat in a path of longitudinal insertion of a pencil into the throat, including plural members extending toward the throat along the path and resiliently biased toward each other for permitting a pencil to be longitudinally inserted into the throat while laterally pressing the inserted pencil between them, and for inhibiting insertion of a human finger into the throat.

3. A sharpener as defined in claim 2, wherein the plural members are two convergent members respectively having free end portions extending toward the throat on opposite sides of the path.

4. A sharpener as defined in claim 3, wherein the squeezer is an integral molded plastic element.

5. A sharpener as defined in claim 3, wherein the two members respectively have converging forward shoulder portions and facing rearward free end portions.

6. A sharpener as defined in claim 5, wherein the free end portions respectively have facing longitudinal grooves for receiving and pressing against opposed side portions of a pencil inserted between them.

7. A sharpener as defined in claim 2, including housing structure laterally surrounding and mounting the holder and squeezer.

8. A sharpener as defined in claim 7, wherein the housing structure comprises a trap for receiving and containing material removed from an end portion of a pencil by the blade within the throat, the holder defining an aperture for discharge of the removed material from the throat into the trap.

9. A sharpener as defined in claim 8, wherein the trap includes two semicylindrical portions interfitting with each other and with the holder to secure the holder and trap portions together in fixed relation to each other, the trap having open front and rear ends.

10. A sharpener as defined in claim 9, further including an open-ended cylindrical outer trap element surrounding said interfitting semicylindrical portions, a cap removably closing the open rear end of the trap, and a forward retaining element fitting over and enclosing the squeezer, the forward retaining element and the squeezer being secured to the forward open end of the trap by interfitting engagement therewith, and the forward retaining element having a forward opening, aligned with said path, for longitudinal insertion of a pencil therethrough between the two members of the squeezer and into the throat.

11. A sharpener for pencils and crayons, comprising, in combination,
(a) a blade holder with a throat having a blade mounted therein to engage and sharpen an end portion of a pencil inserted in the throat;
(b) a squeezer disposed forwardly of the throat for resiliently gripping or squeezing a shaft of a pencil inserted in the sharpener while inhibiting insertion of a child's finger into the throat, wherein the resilient squeezer is capable of gripping or squeezing pencil shafts having any of a range of differing cross-sectional dimensions;
(c) housing structure laterally surrounding and mounting the holder and squeezer, the housing structure including a trap for receiving and containing material removed from an end portion of a pencil by the blade within the throat, the holder defining an aperture for discharge of the removed material from the throat into the trap, the trap having an open rear end; and
(d) a crayon sharpener element removably mounted on and closing the open rear end of the trap, the crayon sharpener element having a throat with at least one plastic blade molded therein to engage and sharpen an end portion of a crayon inserted in the crayon sharpener element throat in a direction opposite to that in which a pencil or crayon is inserted into the blade holder throat, the crayon sharpener element including a housing portion defining a chamber surrounding the crayon sharpener element throat and communicating with the trap through the open rear end thereof, and the crayon sharpener element throat defining an aperture for discharge, into said chamber, of material removed from an end portion of a crayon by said at least one plastic blade.

12. A sharpener as defined in claim 11, wherein the blade mounted in the blade holder is a metal blade for sharpening pencils.

13. A sharpener as defined in claim 12, wherein the crayon sharpener element throat is dimensioned to receive crayons, for sharpening, having shafts larger in diameter than the maximum shaft diameter of a pencil insertable into the blade holder throat.

14. A sharpener as defined in claim 11, wherein the crayon sharpener element including the at least one blade thereof is a unitary, integral molded plastic element and serves as a removable cap for the trap such that the trap can be emptied by removing the crayon sharpener element from the open rear end of the trap.

15. A sharpener as defined in claim 14, wherein the trap includes two semicylindrical portions interfitting with each other and with the holder to secure the holder and tray portions together in fixed relation to each other, the trap having an open front end, and an open-ended cylindrical outer tray element surrounding the interfitting semicylindrical portions.

16. A sharpener as defined in claim 15, further including a forward retaining element fitting over and enclosing the squeezer, the forward retaining element and the squeezer being secured to the forward open end of the trap by interfitting engagement therewith, and the forward retaining element having a forward opening for longitudinal insertion of a pencil there-through into the throat.

17. A sharpener as defined in claim 11, wherein the crayon sharpener element has a plurality of plastic blades molded therein at angularly spaced locations around the throat and a corresponding plurality of said discharge apertures respectively extending along said plastic blades.

18. A sharpener as defined in claim 17, wherein three of said plastic blades molded therein at locations spaced 120° apart around the throat.

19. A sharpener as defined in claim 8, further including a crayon sharpener element removably mountable on the open rear end of the trap with a throat for receiving and sharpening a crayon inserted endwise therein in a direction opposite to that in which a pencil is inserted into the throat of the blade holder.

20. A sharpener for pencils and crayons, comprising, in combination,
(a) a sharpening blade for removing material from an end portion of a pencil;
(b) a blade holder having a throat with an open forward end for receiving an end portion of a pencil inserted longitudinally into the open end, the holder securing the blade in a position for engaging and removing material from an inserted end portion of a pencil within the throat to sharpen the pencil when the holder and the pencil are rotated, relative to each other, about a long axis of the pencil;
(c) housing structure laterally surrounding and mounting the holder and squeezer, the housing structure comprises a trap for receiving and containing material removed from an end portion of a pencil by the blade within the throat, the holder defining an aperture for discharge of the removed material from the throat into the trap; and
(d) a crayon sharpener element removably mountable on the open rear end of the trap with a throat and plastic blade for receiving and sharpening a crayon inserted endwise therein in a direction opposite to that in which a pencil is inserted into the throat of the blade holder, the crayon sharpener element including a housing portion defining a chamber surrounding the crayon sharpener element throat and communicating with the trap through the open rear end thereof, the crayon sharpener element throat defining an aperture for discharge, into said chamber, of material removed from an end portion of a crayon by said plastic blade.
